(19) United States
(12) Patent Application Publication
(10) Pub. No.: US 2005/0071770 A1
(43) Pub. Date: Mar. 31, 2005

(54) Method of personalizing icon on electronic communication product

(75) Inventors: Tai-Shui Ho, Taipei Hsien (TW); Shih-Kuang Tsai, Taipei Hsien (TW); Li Li, Shanghai City (CN); Jian-Feng Tu, Shanghai City (CN); Yong-Kang Liu, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei Hsien (TW)

(21) Appl. No.: 10/671,533

(22) Filed: Sep. 29, 2003

(51) Int. Cl. G06F 3/00

(52) U.S. Cl. 715/765; 715/846; 715/744; 715/747; 715/764; 715/866; 715/810

(57) ABSTRACT

The present invention discloses a method of personalizing icons on an electronic communication product, comprising the steps of installing an image processing program into an electronic communication product, executing the image processing program to edit any icon on the screen of the electronic communication product; connecting an input device (such as a keyboard or a light pen) to the electronic communication product to click on the icon; and selecting the type of desired effect on the original icon; and displaying the edited icon on the screen of the electronic communication product. Such method is applicable for an electronic communication platform of handheld computers such as a handset and a personal digital assistance (PDA).

### BACKGROUND OF THE INVENTION

1. Field of the Invention

The present invention relates to a method of personalizing an icon on an electronic communication product.

2. Description of the Related Art

As electronic communication products such as mobile phones, personal digital assistance (PDA), or handheld computer become more popular and gain a high using percentage. Furthermore, manufacturers offer incentives through promotion activities, the competition of the market gets much severer, and the communication service providers constantly introduce innovative products and services to attract customers.

However, the people of this e-generation no longer satisfy with a pure conversation function of the mobile phone. They expect to have their own handset, which is compact and artistic. In addition to the practical application of each function, the handset has to be cool (such as a handset with 16 ring tones). Therefore, most of the present handsets are compact, but the displaying screen is large and color. Such handset will become the mainstream product in the market, and the colorful icons offered by such product are definitely enjoyable to users.

Since most icons on the screens of current handsets are built-in or downloaded from a network or a personal computer, therefore users cannot edit the icon on the handset. If a user wants to edit an icon on the screen of the handset according to his/her favor, the users has to use a special line provided by the manufacturer of the related brand to send the icon to a personal computer, and then edit the icon by a software provided by such manufacturer. After the icon is edited, it is downloaded to the handset by a special line. Such arrangement not only wastes time and efforts, but also is very inconvenient to users. If some manufacturers do not provide a special line or an editing program at all, then users can only use those icons designed for ordinary users. Even a user has bought a new model, the user can only use the same icons as those for ordinary users. Users will regard such product boring and without personality; in the meantime, this arrangement definitely goes against the trend of looking for cool things by the new e-generation.

Further, since the present handset already provides the function of editing a ring tone, therefore it is an important subject for the manufacturers and service providers to design a handset that allows users to edit and personalize an icon in the handset and meet the current trend of the e-generation handset as well as improve the manufacturer's competitiveness of the market.

### SUMMARY OF THE INVENTION

In view of the current situation that the current handset has provided users the editing function for the ring tone, but it is still unable to edit the icons in the handset yet to obtain personalized icons. Therefore, the inventor of this invention conducted an extensive research and experiment, and finally invented the electronic communication product according to the invention to personalize the icons.

The primary objective of the present invention is to provide a method of personalizing icons on an electronic communication product, and such method is applicable for an electronic communication platform of a handheld computer such as a handset and a personal digital assistance (PDA). As to the icons built in each of the electronic communication products or downloaded from the network or personal computer, the user can personalize such icons anytime and anywhere to satisfy the user's need. Thus, the present invention not only complies with the current trend of the e-generation handset, but also improves the manufacturer's competitiveness of the market.

### BRIEF DESCRIPTION OF THE DRAWINGS

Other features and advantages of the present invention will become apparent in the following detailed description of the preferred embodiments with reference to the accompanying drawings, in which:

FIG. 1 is a flow chart of the present invention.

FIG. 2 is a flow chart of the icon editing procedure of the present invention.

### DETAILED DESCRIPTION OF THE PREFERRED EMBODIMENTS

In recent years, the design and development of electronic communication devices not only tend to be light, thin, and compact to meet the market trend, but their functions and applications also fully satisfy consumer's requirements. Even though the ring tones of the current handset can be edited by users, users are unable to edit the icons on the handset yet. The current handset still cannot meet the cool personalized requirements of the current e-generation consumers.

The present invention focuses on such requirement to invent a method of personalizing icons on an electronic communication product. Such method comprises the steps of installing an image processing program into an electronic communication product 10, and then executing the image processing program by the user to edit an icon on the screen of the electronic communication product 10. When a user wants to edit the browsed icon, the user can use an input device (such as a keyboard or a light pen) connected to the electronic communication product 10 to click on the icon, and select the type of desired effect on the icon and process a corresponding compensation, adjustment, and editing for the original icon. The edited icon is displayed on the screen of the electronic communication product 10. Such method is applicable for the electronic communication product 10 of a handheld computer such as a handset and a personal digital assistance (PDA).

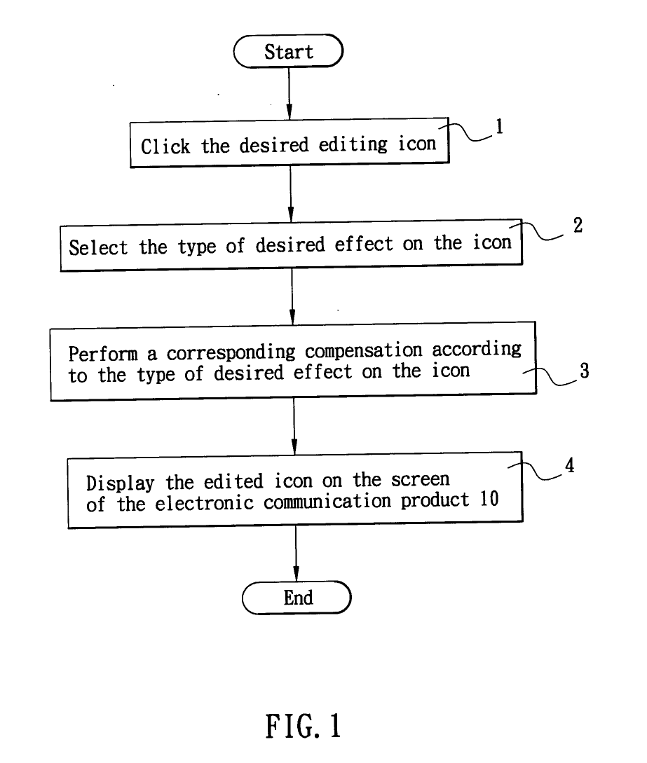

In the present invention, if a user wants to edit the icon browsed from the screen of the electronic communication product 10, the user will process the following procedure (as shown in FIG. 1).

(1) Firstly, an input device is used to click the desired icon for the editing;

(2) Focus on the edited icon to select the type of desired effect on the icon (e.g. selecting a color icon and editing it into a mono-color artistic image, or selecting to fuzzy the surface of the icon, etc);

(3) Perform a corresponding compensation, adjustment, and edit the original icon according to the type of desired effect selected by the user; and

(4) Display the edited icon on the screen of the electronic communication product 10, and end the icon editing operation for this time.

Since many types of effects can be made by the image processing program on the icons of the electronic communication product 10. The aforementioned example relates to converting a color image into a mono-color artistic image, or editing the surface of the image to a waved image, or blurring the surface of the edited icon. Therefore, a preferred embodiment of converting a color image into a mono-color artistic image is used to illustrate the method of this invention.

Further, since the icon displayed on the screen is composed of a large number of pixels (the number of pixels depends on the resolution of the screen), and any pixel is generated by the corresponding cell composed by three colors: red, green, and blue. Therefore, when an icon is displayed on a screen, the color of each pixel is actually the color composed of three mixed colors: red, green, and blue generated by each cell.

Thus, if a color icon is edited into a mono-color image, the following relational formulas will be generated.
R(x,y)=T_{R}[f(x,y)]
G(x,y)=T_{G}[f(x,y)]
B(x,y)=T_{B}[f(x,y)]

Where, T_{R}, T_{G}, and T_{B} respectively stand for the mapping function; f(x,y) stands for the gray-scale icon after the conversion; R(x,y), G(x,y), and B(x,y) are three resultant values corresponding to the red, green, and blue spaces mapped by f(x,y).

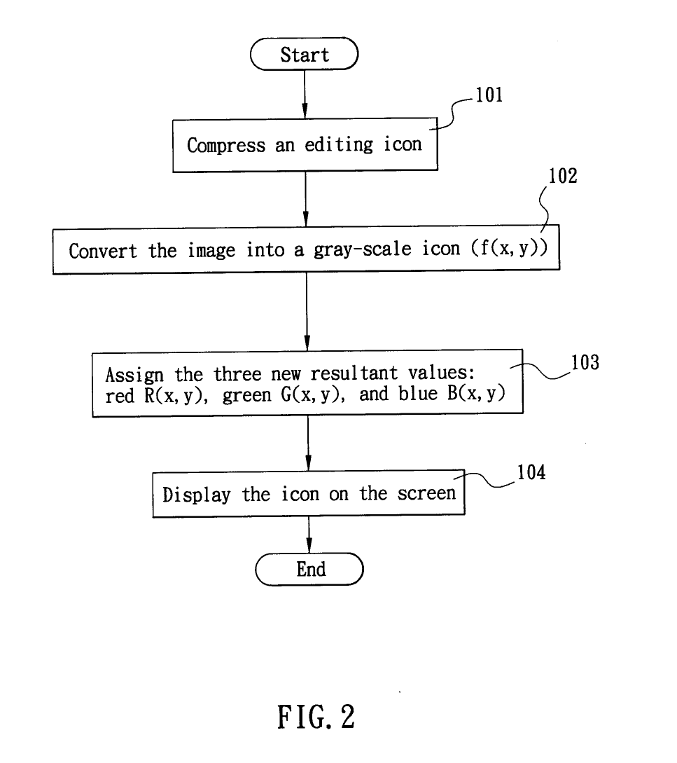

In this preferred embodiment of the present invention, when a user clicks on an icon and wants to edit it into a mono-color artistic icon (which is a type of icon effect), the image processing program will follow the procedure given below to process a compensation, adjustment, and editing to the original icon according to the selected mono-color artistic effect. Please refer to FIG. 2:

(101) Firstly, the editing icon (original icon) is compressed;

(102) Such compressed icon is converted into a gray-scale icon (f(x,y));

(103) Such gray-scale icon is compensated, reorganized, and edited according to the mapping functions T_{R}, T_{G}, and T_{B} as shown in the above formulas to give three new resultant values corresponding to the spaces of the red (R(x,y)) icon, green (G(x,y)) icon, and blue (B(x,y)) icon (for example, if the mono color is red, then the gray scales of the green color and blue color are set to zero, and the red color is adjusted to any value from 0˜255 according to the original gray scale, so that a red scale icon with personalized artistic effect is produced);

(104) The edited icon is displayed on the screen of the electronic communication product 10, and the icon editing operation is completed for this time.

Of course, in the preferred embodiment of this invention, the type of mono color icon physically adopted depends on the values of the red (R(x,y)) icon, green (G(x,y)) icon, and blue (B(x,y)) icon mapped by their corresponding functions T_{R}, T_{G}, and T_{B}. In other words, the processing method of this invention does not change the geometric position of the icon, but only changes the displaying color. Through the user's eyes and the correspondence of the mapping functions T_{R}, T_{G}, and T_{B}, the intended special effect on the icon can be made.

Therefore, users not only can edit ring tones of their handset, but also can personalize icons on the handset to meet the current trend of e-generation handset and the people's personality of looking for cool things in this e-generation.

1. A method of personalizing icon on electronic communication product, comprising the steps of:
installing an image processing program to an electronic communication product to edit an icon;
using said image process program to select an editing icon on the electronic communication product;
reading a type for the desired effect on the editing icon;
performing a corresponding compensation, adjustment, and editing onto the original icon according to said type for the desired effect; and
replacing the original icon with the edited icon for the display.

2. The method of personalizing icon on electronic communication product of claim 1, wherein said editing icon is compressed and converted into a gray-scale icon, and said gray-scale icon is adjusted and compensated with three corresponding resultant values of the spaces of a red, a green, and a blue icon according to a mapping function.

3. The method of personalizing icon on electronic communication product of claim 1, wherein said selected icon is selected by connecting an input device to the electronic communication product.

4. The method of personalizing icon on electronic communication product of claim 1, wherein said electronic communication product includes a handheld computer selected from the collection of a handset and a personal digital assistance.
